(19) United States
(12) Patent Application Publication
(10) Pub. No.: US 2013/0153841 A1
(43) Pub. Date: Jun. 20, 2013

(54) WINCH OPERATED HOIST AND METHOD OF OPERATING SAME

(71) Applicant: Jerry H. SCHUMACHER, Boone, NC (US)

(72) Inventor: Jerry H. SCHUMACHER, Boone, NC (US)

(21) Appl. No.: 13/331,600

(22) Filed: Dec. 20, 2011

(51) Int. Cl. B66D 1/36

(52) U.S. Cl. 254/338

(57) ABSTRACT

A winch operated hoist has a first elongated vertical member is operatively attached at a lower end thereof to a frame. A second elongated vertical member telescopically disposed in the first elongated member. A third elongated member operatively attached to a top end of the second elongated member, the third elongated member being perpendicular to the second elongated member, the third elongated member being operatively pivotally disposed with respect to the first elongated member about a substantially vertical axis. Using a series of idler pulleys, over which a cable of the winch is trained, the second elongated member telescopes up to raise a load higher than it could be lifted using prior art technology.

### TECHNICAL FIELD

This invention relates generally to hoists and more particularly to a winch operated hoist.

### BACKGROUND

Hoists of various kinds are known in the art. For example, U.S. Pat. No. 6,152,675 to Compton shows a winch operated hoist of a type designed to attach to a vehicle receiver hitch. The distance that a load to be lifted in this type of a device is limited by the length of a vertical post that extends upwardly, though Compton uses a two piece vertical post that permits the length of the vertical post to be adjustable by manually telescoping the inside post up and pinning it to a desired height using holes in the two piece post and using a pin through aligned holes in the adjusting process. This manual adjusting process is manageable but with one person may be difficult to lift the inside post to align the holes in the inner and outer tubes and then placing a pin through the aligned holes.

Accordingly, there is a need for a more automatic way to provide a hoist of the Compton type which does not require manual adjusting of the main vertical post in order to lift a load higher than the length of the main vertical post of the hoist.

### BRIEF DESCRIPTION OF THE DRAWINGS

The above needs are at least partially met through provision of the method and apparatus described in the following detailed description, particularly when studied in conjunction with the drawings, wherein:

FIG. 1 is a side view of a hoist constructed in accordance with the present invention shown in preparation for lifting a load;

FIG. 2 is a side elevational view, like FIG. 1, but showing the hoist having lifted the load through a first stage;

FIG. 3 is a side elevational view, like FIGS. 1 and 2, but showing a second stage of lifting from FIG. 2 wherein a second elongated tube member is caused to move up due to a winch and idler pulley system, showing partial movement upwardly of the inner elongated tube in solid lines and even more movement upwardly of the inner elongated is shown in dashed lines as the winch is used to wrap more cable onto the reel thereof and also shows in dashed lines pivoting a horizontal beam by one hundred and eighty degrees;

FIG. 4 is an enlarged cross sectional view taken at the circle 4 of FIG. 3;

FIG. 5 is an enlarged cross sectional view taken at the circle 5 of FIG. 3;

FIG. 6 is an enlarged cross sectional view taken at the circle 6 of FIG. 3; and

FIG. 7 is a side elevational view like FIG. 3 in the raised and pivoted position in dashed lines, and showing the load being lowered by letting the cable unwind off of the reel of the winch.

FIG. 8 is an exploded cross sectional view similar to the cross sectional view of FIG. 6 to show the details of how a bushing is used to allow the horizontal third beam to pivot about a vertical axis;

FIG. 8A is a view taken along line 8A-8A of FIG. 8; and

FIG. 8B is a view taken along line 8B-8B of FIG. 8.

Elements in the Figures are illustrated for simplicity and clarity and have not necessarily been drawn to scale. For example, the dimensions and/or relative positioning of some of the elements in the Figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

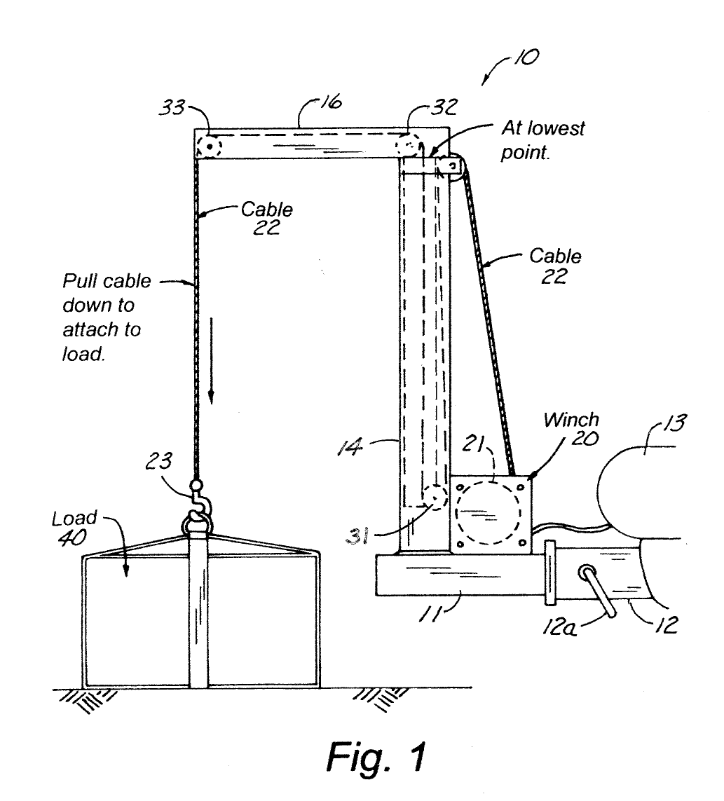

Referring now to the drawings wherein like reference numerals designate identical or corresponding parts throughout the several views, FIG. 1 shows a hoist 10 constructed in accordance with the present invention. A frame 11 is shown telescoping into a receiver hitch tube 12 of a vehicle 13 in the conventional way a ball hitch would be attached to the receiver 12 of a vehicle 13, using a pin 12a that passes through aligned holes in the receiver 12 and frame 11 to hold the frame 11 securely attached to the vehicle 13.

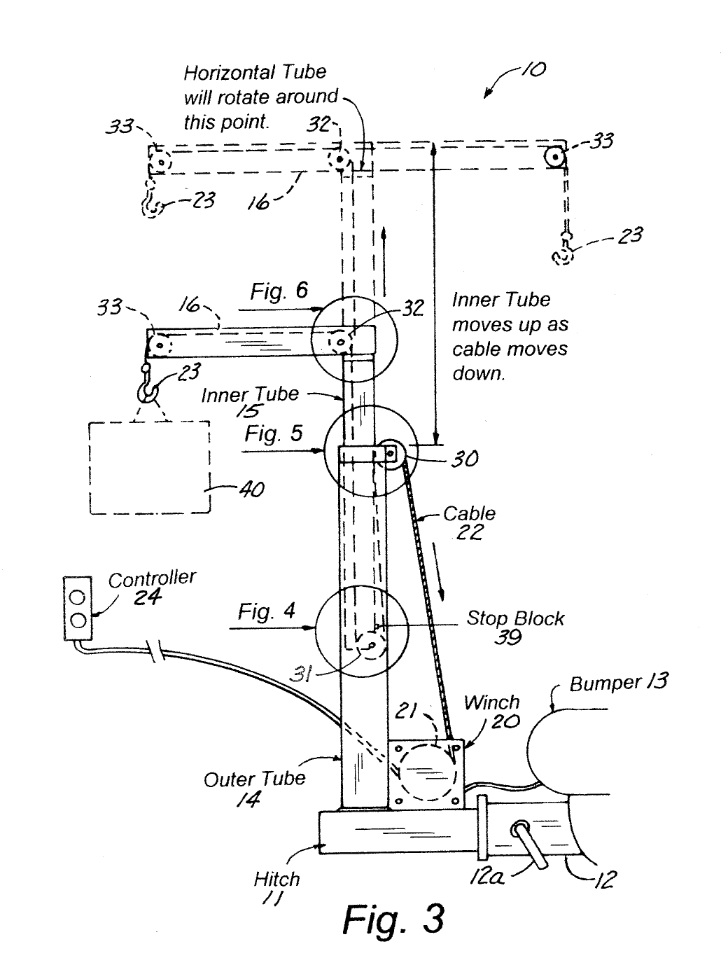

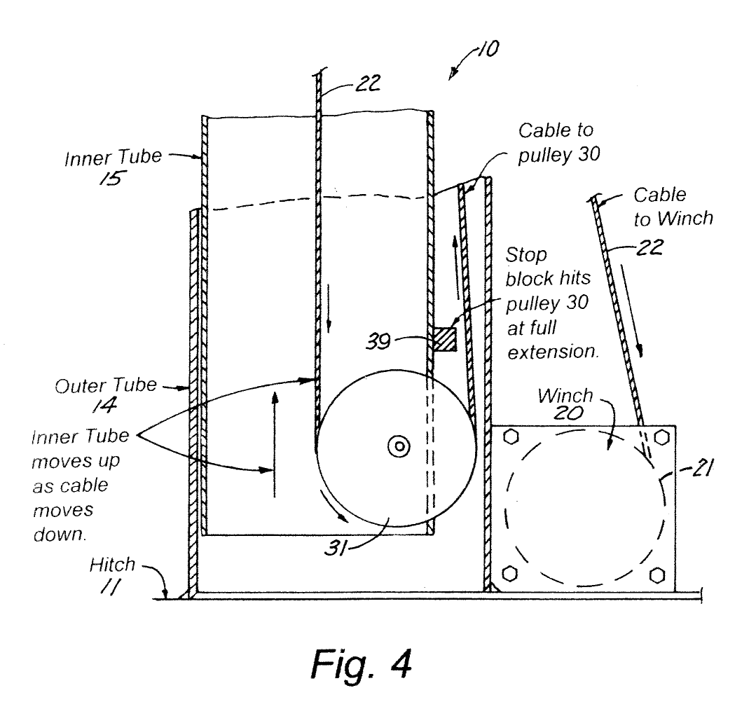

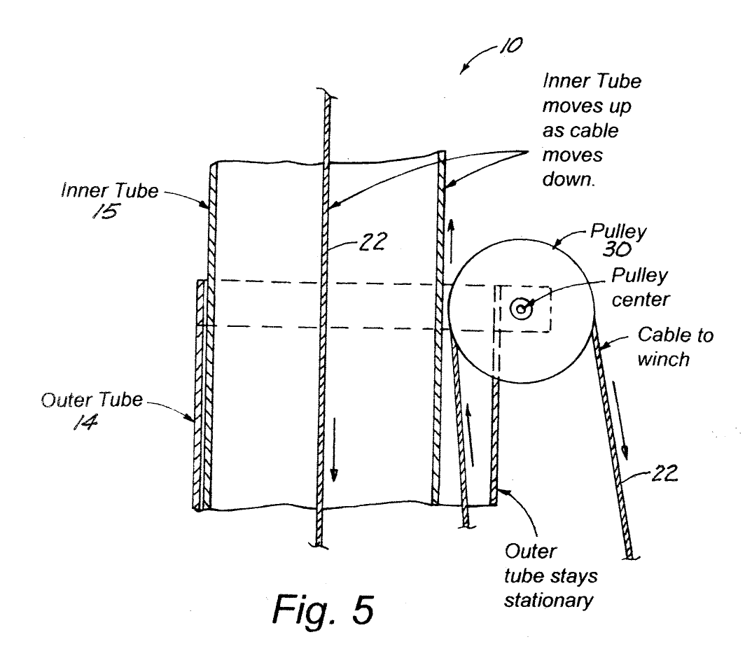

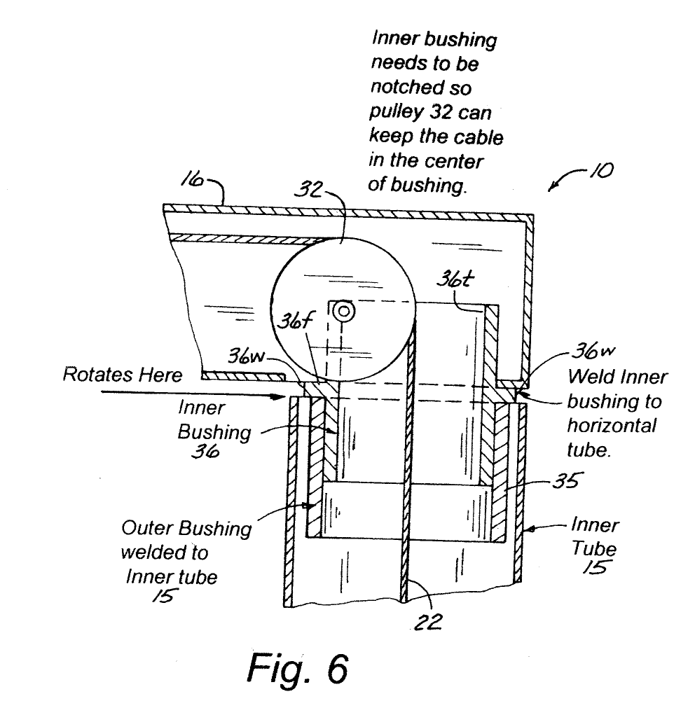

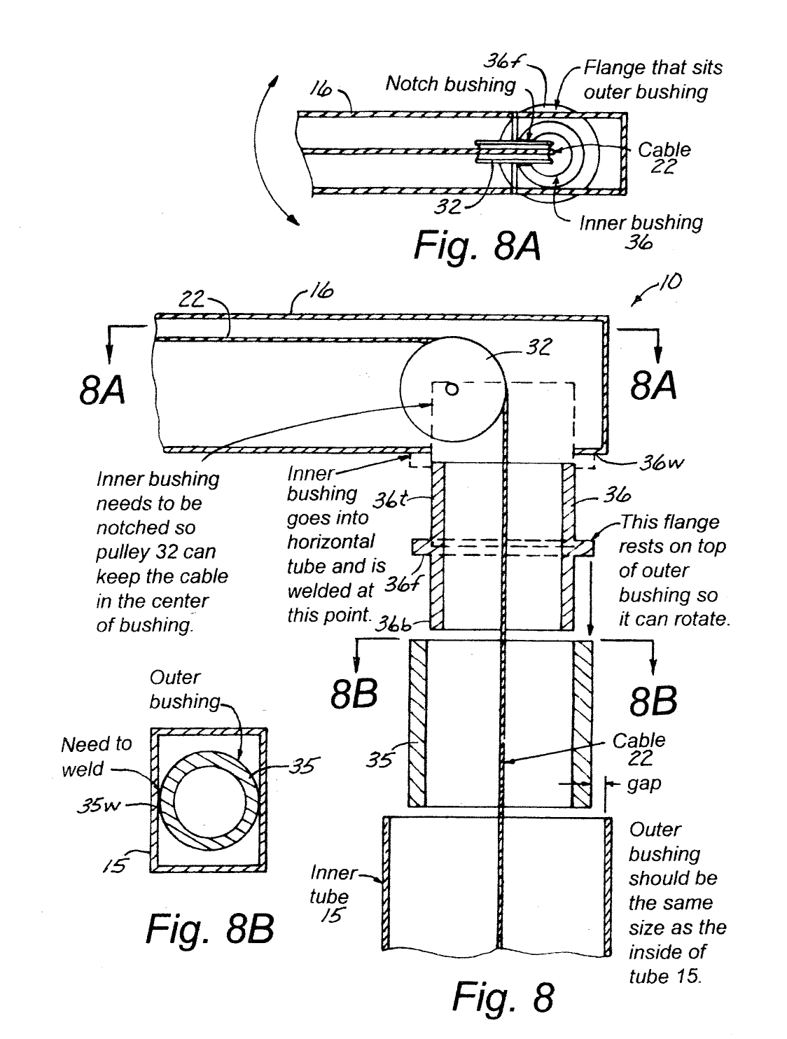

Referring now to FIGS. 1-3, a first elongated steel tube member 14 is rigidly attached to the frame 11 and has a second elongated steel tube member 15 telescopingly disposed inside of the first elongated steel tube member 14. A third elongated steel member 16, which is preferably a U-shaped member but can be of other configurations, is pivotally mounted to the top of the second elongated steel tube member 15 via a bushing 17 as can best be seen in FIGS. 6 and 8. This allows the elongated steel U-shaped member 16 to pivot about a vertical axis between the two positions shown in FIG. 3 in dashed lines and can in fact pivot three hundred sixty five degrees about the vertical axis of tube 15.

An electric winch 20 shown in FIGS. 1-3 and 7 is operatively attached to the frame 11, or to the first elongated steel tube member 14, or both. This winch 20 does not need to be electrically operated, but could be operated with a hand crank or hydraulically, for example. The winch 20 has a reel 21 shown in dashed lines. The reel 21 is shown rotatable about a horizontal axis. One end of a cable 22 is attached to the reel 22 of the winch 20. The other end of the cable 22 has a hook 23 attached thereto.

The cable 22 of the winch 20 is trained over an idler pulley 30 that is rotatably attached to the top of the first elongated steel tube member 14, then under a second idler pulley 31 that is rotatably attached to the bottom of the second elongated steel tube member 15. The cable 22 is then trained over the top of a third idler pulley 32, the third idler pulley 32 being rotatably attached to the third elongated member 16 and then over a second idler pulley 33 that is also rotatably attached to the third elongated steel member 16.

FIGS. 6, 8 and 8B show an outer bushing 35 welded or otherwise fastened rigidly to the inner steel tube 15. An inner bushing 36 has an intermediate annular flange 36f between a top cylindrical part 36t and a bottom cylindrical part 36b. The bottom cylindrical part 36b of the inner bushing 36 slides into the outer bushing 35 so it can rotate with respect to the outer bushing The upper part of the inner bushing 36t slides into a notch formed in the horizontal arm 16 and the flange 36f is welded or otherwise fastened to the horizontal arm 16 as can be seen by weld 36w in FIG. 6 so that the inner bushing is fixed with respect to arm 16 and can pivot with respect to the outer bushing 35 to allow the horizontal arm 16 to pivot about a vertical axis coincident with the vertical axis of in inner bushing 36 and the outer bushing 35.

In operation the winch 20 would be used to attach to a load 40 by letting out enough cable 22 so the hoist 10 would be in the configuration shown in FIG. 1 with the third elongated steel member/arm 16 effectively in abutment with the top of the first elongated steel tube member 14 though the actual structure at this joint is shown in FIGS. 6 and 8.

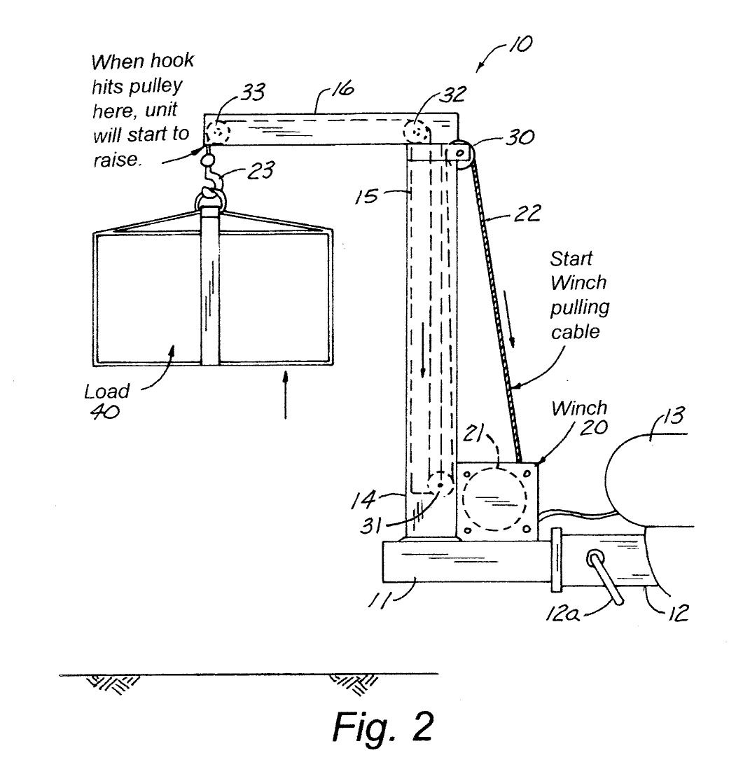

Then the winch 20 is used to wind the cable 22 onto the reel 21 as shown in FIG. 2 to lift the load 40 until the hook 23 hits the idler pulley 33 at the free end of the elongated steel member/arm 16.

Continuing to use the winch 20 by using the electronic switch controller 24 shown in FIG. 3 to wind cable 22 onto the reel from the position shown in FIG. 2 will cause the load 40 to continue to move upwardly as shown in FIG. 3 because the cable 22 will force the lower idler pulley 31 to move upwardly as the cable 22 is shortened, thereby forcing the inner tube 15 and elongated steel member/arm 16 upwardly first to the intermediate position shown in solid lines in FIG. 3, and, with continued reeling in of the cable 22 will cause the load 40 to move upwardly to the dashed lined position shown in FIG. 3, on the left side of FIG. 3.

It is noted that a stop block 39 rigidly attached to the inner tube 15 will abut the upper idler pulley 30 as the inner tube 15 moves upwardly and the inner tube 15 will stop moving upwardly once the stop block hits the idler pulley 30 corresponding to the extreme upper position of the inner tube 15 and horizontal arm 16 shown in dashed lines in FIG. 3. Once the load 40 is at that extreme top position shown in dashed lines in FIG. 3, the elongated steel member/arm 16 can be pivoted by hand to the right side position shown in FIG. 3 if desired to drop the load 40 on the right side of the inner and outer tubes 15 and 14 respectively, or at any pivoted position 360 degrees around the vertical axis of the bushings 35 and 36 (FIGS. 6 and 8.)

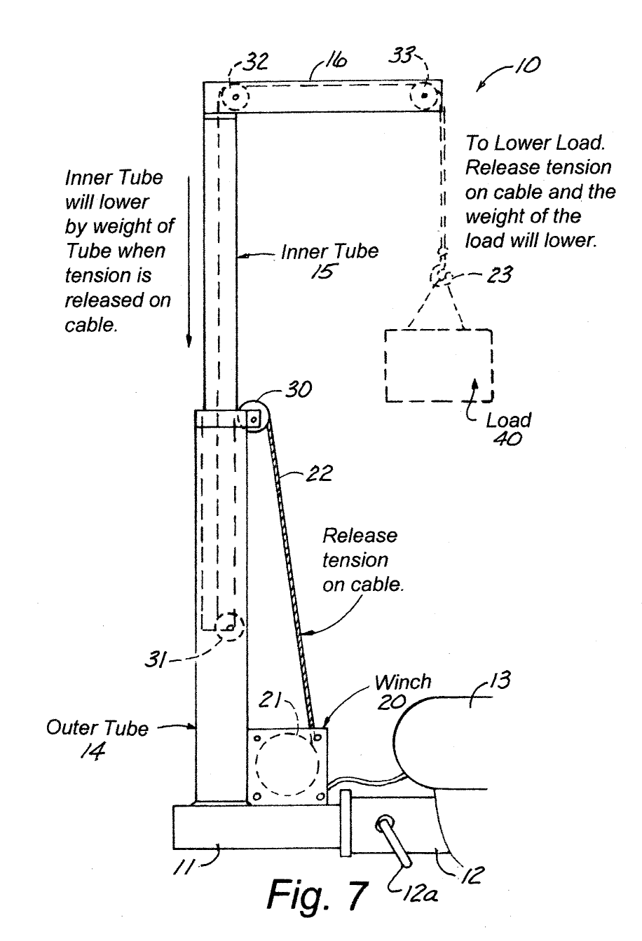

FIG. 7 shows that slowly unwinding the cable 22 from the winch 20 will allow the load 40 to be lowered as much as is desired, for example to a top of the vehicle, not shown. The entire operation can then be repeated with a second load 40 by reversing and then repeating the process just explained above, i.e. raise the hook 23, manually pivoting the elongated steel member/arm 16 to the FIG. 3 position, lowering the elongated steel member/arm 16 to the FIG. 1 position, hooking on the new load 40, etc.

FIG. 8B shows how member 35 is welded to tubular member 15 at weld 35w.

It is to be understood that the present invention 10 can be used in other places than just attached to the receiver hitch 12 of a vehicle 13. For example the invention 10 is quite useful at construction sites where materials need to be moved to one or more higher levels or stories of a building and is extremely useful for constructing log homes where the logs need to be lifted from a truck to the elevated locations where needed. The hoist 10 can be moved from one level of a log home under construction to the next higher level as the home is being built until it is at the roof level where roofing materials can also be elevated until all of the parts of the building or home have been lifted to the height needed for such construction project.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one illustrative example in these regards, the aforementioned substrate 200 can be molded to include some or all of the aforementioned channels. As another illustrative example in these regards, the aforementioned algorithm can be normalized as desired over a given length or total range and can be customized for essentially any angle, frequency, or line spacing as may be desired.

1. A winch operated hoist comprising:
a frame;
a first elongated member operatively attached at a lower end thereof to the frame;
a second elongated member telescopically disposed in the first elongated member;
a third elongated member operatively attached to a top end of the second elongated member, the third elongated member being disposed transversely with respect to the second elongated member, the third elongated member being operatively pivotally disposed with respect to the first elongated member about a substantially vertical axis;
a winch operatively attached to at least one of the frame and first elongated member, the winch having a reel with a flexible cable having one end thereof operatively attached thereto and the other end being a free end;
a first idler pulley operatively rotatably attached to a top portion of the first elongated member;
a second idler pulley operatively rotatably attached to a bottom portion of the second elongated member;
a third idler pulley operatively rotatably attached to a first portion of the third elongated member;
a fourth idler pulley operatively rotatably attached to a second portion of the third elongated member, the fourth idler pulley being spaced a distance farther from the first elongated member than the distance of the third idler pulley is from the first elongated member;
the cable being trained over the first idler pulley, under the second idler pulley and over the third and fourth idler pulleys; and
the free end of the cable being adapted to attach a load to be lifted thereto.

2. The winch operated hoist of claim 1 wherein the second elongated member is operatively pivotally attached to a top end of the first elongated member.

3. The winch operated hoist of claim 1 wherein the first elongated member is a tube and the second elongated member is at least partially disposed within the first elongated member.

4. The winch operated hoist of claim 1 wherein a stop operatively attached to the second elongated member limits the extent that the second elongated member will extend above the top of the first elongated member.

5. The winch operated hoist of claim 1 wherein the second elongated member is a tubular member.

6. The winch operated hoist of claim 1 wherein the free end of the cable has a hook thereon for selective attachment to a load to be lifted.

7. A method of using a winch operated hoist of a type comprising
a frame;
a first elongated member operatively attached at a lower end thereof to the frame;
a second elongated member telescopically disposed in the first elongated member;
a third elongated member operatively attached to a top end of the second elongated member, the third elongated member being disposed transversely with respect to the second elongated member, the third elongated member being operatively pivotally disposed with respect to the first elongated member about a substantially vertical axis;
a winch operatively attached to at least one of the frame and first elongated member, the winch having a reel with a flexible cable having one end thereof operatively attached thereto and the other end being a free end; a first idler pulley operatively rotatably attached to a top portion of the first elongated member;
a second idler pulley operatively rotatably attached to a bottom portion of the second elongated member;
a third idler pulley operatively rotatably attached to a first portion of the third elongated member;
a fourth idler pulley operatively rotatably attached to a second portion of the third elongated member, the fourth idler pulley being spaced a distance farther from the first elongated member than the distance of the third idler pulley is from the first elongated member;
the cable being trained over the first idler pulley, under the second idler pulley and over the third and fourth idler pulleys;
and the free end of the cable being adapted to attach a load to be lifted thereto, said method comprising:
attaching the free end of the cable to a load;
turning the reel of the winch in one rotary direction to cause the cable to wind onto the reel until the load is lifted off of the ground;
continuing to rotate the reel in the one rotary direction until the free end of the cable stops with respect to the fourth idler pulley;
continuing to rotate the reel in the one rotary direction until the second and third elongated members and the load are raised to a desired level due to the second elongated member moving upwardly with respect to the first elongated member;
pivoting the third elongated member along a vertical axis until the load is above a place where it is desired to place the load;
reversing the rotary direction of the reel of the winch to allow the cable to be unwound from the reel whereby the second and third elongated members and the load will be lowered to the place where the load is desired to be placed; and
releasing the load from the free end of the cable.

8. The method of claim 7 further comprising:
pivoting the third elongated member along a vertical axis;
continuing to turn the reel in said reversed direction to cause the cable to unwind off of the reel until the second elongated member lowers with respect to the first elongated member and the free end of the cable is at a level low enough to be attached to a second load; and
repeating the steps of claim 7 to move the second load to an elevated place.
